(19) United States
(12) Patent Application Publication
(10) Pub. No.: US 2018/0173006 A1
(43) Pub. Date: Jun. 21, 2018

(54) EYEGLASS WITH ANGLE OF LENS ADJUSTABLE DEPENDING ON MULTI FOCUS LENS

(71) Applicant: Gold Rice Optical Co., Ltd., Taipei (TW)

(72) Inventor: Cheng Hu, Taipei (TW)

(21) Appl. No.: 15/608,455

(22) Filed: May 30, 2017

(30) Foreign Application Priority Data
Dec. 21, 2016 (TW) 105142341

(51) Int. Cl. G02C 5/20; G02C 7/08; G02C 5/22

(52) U.S. Cl. CPC G02C 5/20; G02C 9/00; G02C 5/22; G02C 7/081

(57) ABSTRACT

An eyeglass with angle of lens adjustable depending on multi focus lens includes a frame and two lenses. The frame is provided with a rim and two temples. The rim is provided with two rotating portions located at two opposite outer sides of the rim. Each temple is provided with a mounting portion pivotally connected to one of the rotating portions. The lenses are mounted to the rim symmetrically. In this connection, each lens is provided with a regular-prescription area having vision zones. The vision zones include a short-range vision zone, a middle-range vision zone and a long-range vision zone. When the present invention is used, the rotational cooperation of the short-range vision zone, middle-range vision zone and long-range vision zone with the temples is utilized, so as to solve the problem of incapability of aligning lenses in the conventional practice with eyes suffering from presbyopia.

### FIELD OF THE INVENTION

The present invention is related to an eyeglass with angle of lens adjustable depending on multi focus lens, particularly to an eyeglass enabling alignment between regular-prescription areas and eyes suffering from presbyopia via rotation.

### BACKGROUND OF THE INVENTION

It is found that life of people has been rife with televisions, mobile phones, electronic advertising panels and any electronic devices with displays as electronic technology highly develops, which is accompanied by gradually degraded vision of eyes of people and also rapidly risen eyeglass wearing rate of the vulgar. In the light of this, there are also manufacturers researching and developing an eyeglass with adjustable angle of leg at present for the enhancement of comfort in wearing the eyeglass. For instance, a structure for adjusting angle of lens stand of eyeglass is disclosed in Taiwan patent no. 293516. The eyeglass includes a lens stand, two connecting stands, two earpieces and two engaging components. The two connecting stands are provided at two opposite sides of the lens stand. Each of the two engaging components is provided at one end of one of the earpieces, respectively, and each of the two earpieces is mounted to one of the connecting stands via one of the engaging components, respectively. When the eyeglass is put into practical use, the user is allowed to adjust the position of each of the two engaging components on one of the connecting stands, whereby the set angle between the two earpieces and the lens stand is changed, such that the eyeglass, worn on the face of the user, is capable of following undulation of the skeleton of the face of the user, and further, enhancing wearing comfort of the eyeglass.

It may be found, in terms of the content written in patent no. 293516, eyes suffering from presbyopia are capable of viewing external objects clearly through two lenses because the set angle of the two lenses is changed after the set angle of the two earpieces is changed. Furthermore, it is also impossibly known from the content written in patent no. 293516 how eyes suffering from presbyopia cooperate with the two lenses set at a changeable angle. In the light of this, how to design an eyeglass capable of changing the set angle of temples and enabling lenses to match up presbyopic prescription has obviously become a problem to be solved.

### SUMMARY OF THE INVENTION

It is the main object of the present invention to solve the problem of incapability of aligning lenses set at a changeable angle in the conventional practice with eyes suffering from presbyopia.

For achieving the above objects, the present invention provides an eyeglass with angle of lens adjustable depending on multi focus lens, including a frame and two lenses. The frame is provided with a rim and two temples provided at two opposite outer sides of the frame. The rim is provided with a bottom side defined and formed by the bottom of the rim, a top side defined and formed by the top of the rim, and two rotating portions located at two opposite outer sides of the rim. Each of the two temples is provided with a mounting portion pivotally connected to one of the rotating portions. Each of the rotating portions is provided with a releasing plate. Each of the mounting portions is provided with a connecting slot provided for one of the rotating portions to be situated therein, and an axle hole provided on an inner wall of the connecting slot and provided for one of the releasing plates to be situated therein, such that the temple is allowed to revolve around one of the releasing plates as an axle center. Each of the rotating portions is provided with a plurality of resilient ratchets juxtaposed with the releasing plate, and arranged about the center of the releasing plate as a center of circle. Each of the mounting portions is provided with a plurality of fixed ratchets provided inside the connecting slot and engaged with the resilient ratchets. The two lenses are mounted to the rim symmetrically. Each of the lenses is provided with two irregular-prescription areas, and a regular-prescription area located between the two irregular-prescription areas. Each of the regular-prescription areas is provided with a plurality of vision zones. In this connection, the vision zones include a short-range vision zone, a middle-range vision zone and a long-range vision zone provided from the bottom side of the rim toward the top side of the rim in turn. The prescription of the short-range vision zone is the presbyopic prescription of a user. The prescription of the long-range vision zone is the prescription of the short-range vision zone divided by two. The prescription of the middle-range vision zone is equivalent to the summation of prescription of the short-range vision zone and that of the long-range vision zone divided by two.

In one embodiment, the vision zones further include a shortest-range vision zone located between the bottom side and the short-range vision zone, and the prescription of the shortest-range vision zone is the prescription of the short-range vision zone plus 0.15 to 0.6 diopters.

In one embodiment, the vision zones further include a longest-range vision zone located between the top side and the long-range vision zone, and the prescription of the longest-range vision zone is the prescription of the long-range vision zone plus 0.15 to 0.6 diopters.

In one embodiment, the eyeglass with angle of lens adjustable depending on multi focus lens is provided with a plurality of fixed positions, where the fixed ratchets are engaged with any number of the resilient ratchets for the two temples, the number of the fixed positions being larger than or equal to that of the vision zones.

On account of the above practice, the present invention is provided, in comparison with the conventional practice, with features as follows.

The rotational cooperation between the vision zones and the temples is utilized by the present invention to enable alignment between the regular-prescription areas and eyes suffering from presbyopia of the user, whereby the problem of incapability of aligning lenses set at a changeable angle in the conventional practice with eyes suffering from presbyopia is solved.

### BRIEF DESCRIPTION OF THE DRAWINGS

FIG. 1 is a schematic exploded view of the present invention.

FIG. 2 is a schematic cross-sectional side view of one embodiment of the present invention.

FIG. 3 is a schematic partial perspective view of one embodiment of the present invention.

FIG. 4 is a schematic cross-sectional side view (I) of one embodiment of the present invention being used.

FIG. 5 is a schematic cross-sectional side view (II) of one embodiment of the present invention being used.

FIG. 6 is a schematic partial perspective view of another embodiment of the present invention.

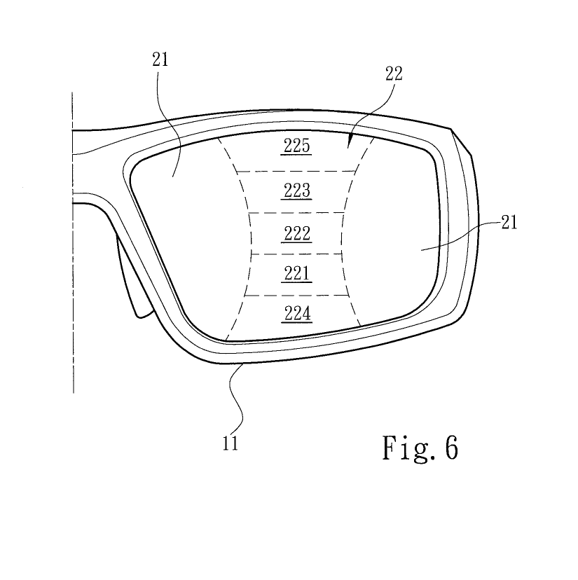

### DETAILED DESCRIPTION OF THE PREFERRED EMBODIMENTS

The detailed description and technical content of the present invention will now be described in conjunction with drawings as follows.

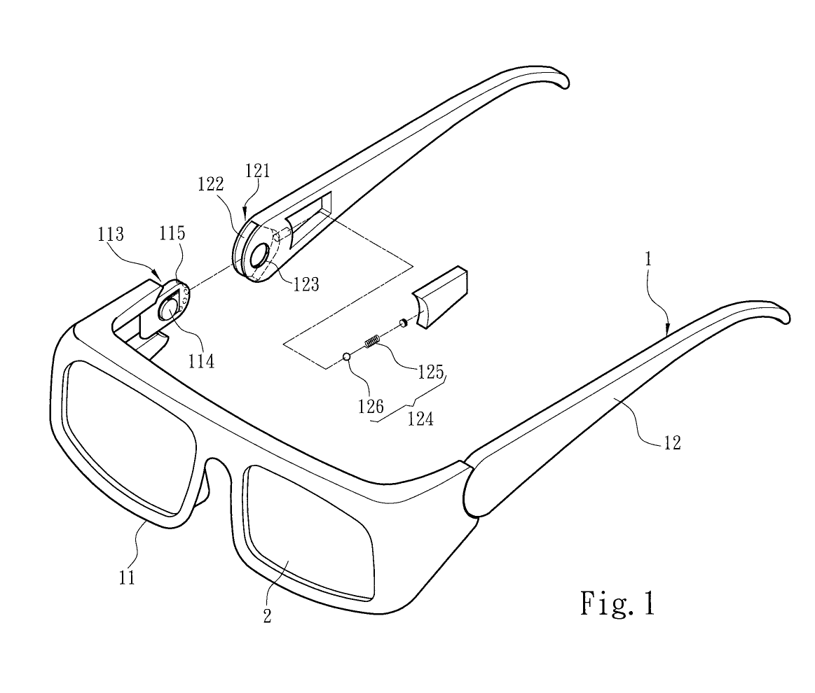

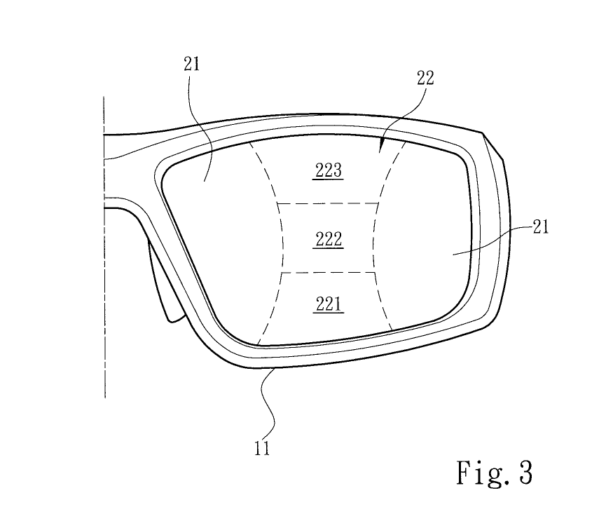

Referring to FIGS. 1-3, the present invention provides an eyeglass with angle of lens adjustable depending on multi focus lens, the eyeglass with angle of lens adjustable depending on multi focus lens, provided for a user having eyes suffering from presbyopia to wear, including a frame 1 and two lenses 2. The frame 1 is provided with a rim 11 and two temples 12. Moreover, each of two opposite outer sides of the frame 1 is respectively provided for one of the temples 12 to be mounted, such that the two temples 12 are mirroredly oriented with respect to a center line of the rim 11 as an axis of symmetry. The rim 11 is provided with a bottom side 111, a top side 112 and two rotating portions 113, in which the bottom side 111 is defined and formed by the bottom of the rim 11, the top side 112 is defined and formed by the top of the rim 11 and opposite to the bottom side 111, as well as the two rotating portions 113 are located at two opposite outer sides of the rim 11 so as to be opposite to each other, as illustrated in FIG. 1. Each of the two temples 12 is provided with a mounting portion 121, and each of the mounting portions 121 is pivotally connected to one of the rotating portions 113, such that each of the temples 12 is allowed to revolve with respect to one of the rotating portions 113 as an axle center, respectively. On the other hand, each of the lenses 2 is provided with two irregular-prescription areas 21 and a regular-prescription area 22, as well as the two lenses 2 are mounted to the rim 11 and mirroredly oriented with respect to the center line of the rim 11 as a symmetrical axis, as illustrated in FIGS. 1-3. As can be seen from the structure of one lens 2, the regular-prescription area 22 is located between the two irregular-prescription areas 21, the two irregular-prescription areas 21 being aligned with the positions of human eyes having irregular prescription, the regular-prescription area 22 being aligned with the position of human eyes having regular prescription. In this connection, the regular-prescription area 22 is provided with a plurality of vision zones, the vision zones including a short-range vision zone 221, a middle-range vision zone 222 and a long-range vision zone 223, the short-range vision zone 221, the middle-range vision zone 222 and the long-range vision zone 223 are provided from the bottom side 111 toward the top side 112 in turn (as shown in FIG. 3). The prescription of the short-range vision zone 221 is the presbyopic prescription of the user. The prescription of the long-range vision zone 223 is the prescription of the short-range vision zone 221 divided by two. The prescription of the middle-range vision zone 222 is equivalent to the summation of prescription of the short-range vision zone 221 and that of the long-range vision zone 223 divided by two. It can be seen from this that the prescription of the regular-prescription area 22 of the lens 2 is designed to be decreased gradually from the bottom side 111 toward the top side 112. In one embodiment, the middle-range vision zone 222 is located at the center of the lens 2; while in another embodiment, the middle-range vision zone 222 is not located at the center of the lens 2.

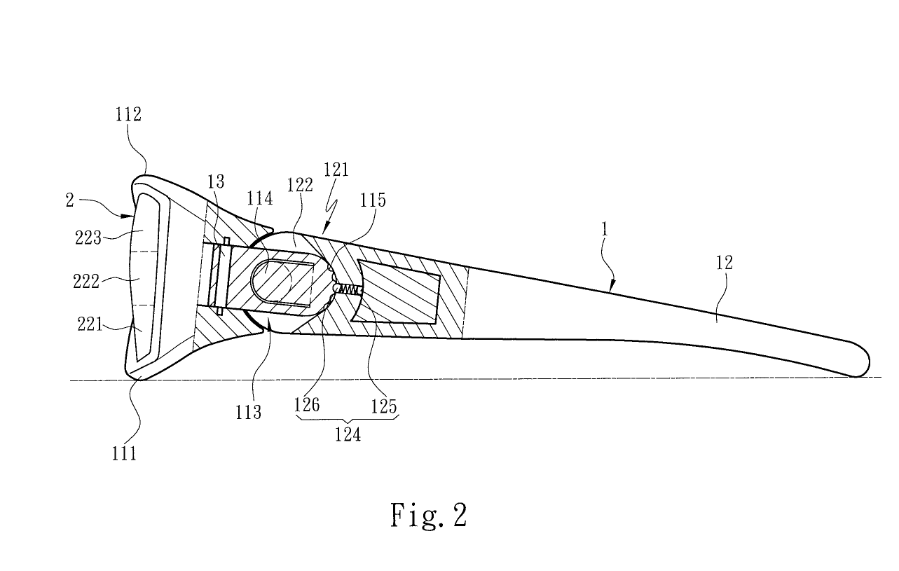

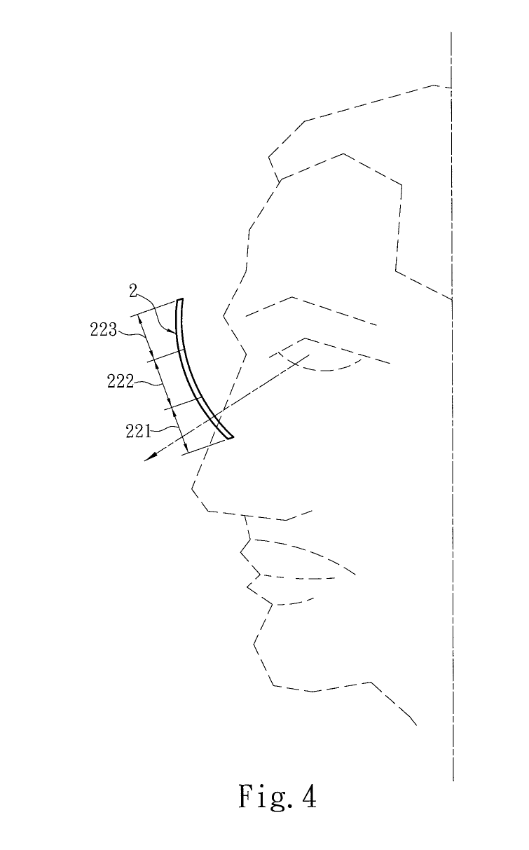

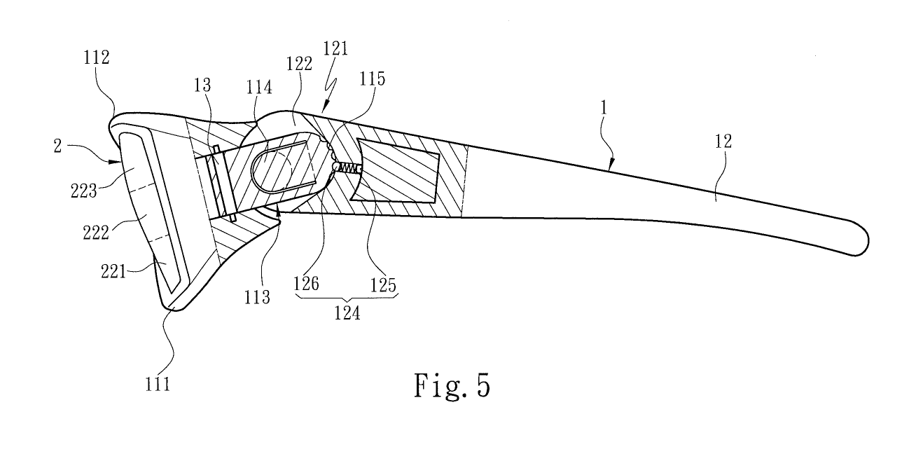

The constituting structure of the frame 1 and the lens 2 has been understood clearly through the above technical content. Here, the process of operation of the eyeglass with angle of lens adjustable depending on multi focus lens will be described further in the present invention. In addition, it should be expressly stated that, due to no difference between the two temples 12 and that between the two lenses 2 appearing in the implementation process, only one temple 12 and one lens 2 are taken for explanation in the subsequent description. Then, in the operation process of the eyeglass with angle of lens adjustable depending on multi focus lens, the temple 12 may be hooked over the ear by the user, such that the lens 2 mounted to the rim 11 is aligned with the eye of the user. In detail, human line of sight is stayed at a position under the direct light of sight (i.e., a position where the eyes looks downward slightly) most frequently (and most comfortably). In this connection, if the lens 2 is incapable of aligning with the aforementioned position where human line of sight is stayed most frequently after the frame 1 is worn by the user, the temple 12 may be revolved upward or downward by the user via the rotating portion 113 as required. Thereby, the angle of the lens 2 with respect to the eye of the user is changed, so as to enable the short-range vision zone 221 to align with the position where line of sight of the user is stayed most frequently (as shown in FIGS. 2, 4 and 5). In this way, eyes suffering from presbyopia of the user may be allowed to view the object closer to the user through the short-range vision zone 221 with higher presbyopic prescription in the most comfortable position. Further, the object farther from the user may be viewed through the middle-range vision zone 222 and the long-range vision zone 223 with lower presbyopic prescription when line of sight of eyes is shifted upward to look afar. Accordingly, the short-range vision zone 221, the middle-range vision zone 222 and the long-range vision zone 223 may be cooperated with the rotation of the temple 12 to enable the regular-prescription area 22 to align with the eye suffering from presbyopia of the user. Thereby, the problem of incapability of aligning lenses set at a changeable angle in the conventional practice with eyes suffering from presbyopia is solved.

In the above embodiment, one regular-prescription area 22 having three vision zones (i.e., the short-range vision zone 221, the middle-range vision zone 222 and the long-range vision zone 223) is exemplified for the present invention. More than three vision zones of this type, however, may be actually provided in accordance with the requirement of the user. In one embodiment, the vision zones further include a shortest-range vision zone 224 located between the bottom side 111 and the short-range vision zone 221, and the prescription of the shortest-range vision zone 224 is the prescription of the short-range vision zone 221 plus 0.15 to 0.6 diopters. In another embodiment, the vision zones further include a longest-range vision zone 225 located between the top side 112 and the long-range vision zone 223, and the prescription of the longest-range vision zone 225 is the prescription of the long-range vision zone 223 plus 0.15 to 0.6 diopters.

The main realized content of the present invention has been clear in the above paragraphs. Here, other embodiments of the eyeglass with angle of lens adjustable depending on multi focus lens will be further explained. In detail, as illustrated in FIGS. 1-5, the frame 1 may be provided with two shaft portions 13 (not shown in the figures). Each of the two shaft portions 13 is provided between one of the rotating portions 113 and the rim 11, respectively, in such a way that each of the two temples 12 is folded toward the rim 11 with respect to one of the shaft portions 13. In one embodiment, each of the rotating portions 113 is provided with a releasing plate 114, while each of the mounting portions 121 is provided with a connecting slot 122 and an axle hole 123 provided inside the connecting slot 122. It can be seen that, from the structure assembled with one rotating portion 113 and one mounting portion 121, the releasing plate 114 may be in the form of a circle or a shape with perimeter located on an identical circumference (for instance, crisscross or equilateral triangle). The connecting slot 122 may be provided for the rotating portion 113 to be situated therein, while the axle hole 123 may be in the form of a circle for covering the perimeter of the releasing plate 114, in such a way that the temple 12 is allowed to revolve around the releasing plate 114 as a center of circle, as illustrated in FIGS. 1-5. Furthermore, the releasing plate 114 is presented in a resilient plate- or retaining plate-like type; that is to say, the position of the releasing plate 114 is changed in accordance with the press from the user, and the releasing plate 114 is restored to the original position resiliently without being pressed. In this way, the rotating portion 113 is retained to the axle hole 123 through the releasing plate 114 after being located into the connecting slot 122. Moreover, the releasing plate 114 may be pressed by the user via the axle hole 123 so as to relieve the retained state between the releasing plate 114 and the axle hole 123, and further, pull out the temple 12 away from the side of the rim 11.

Furthermore, in one embodiment, each of the rotating portions 113 is provided with a plurality of positioning slots 115, and each of the mounting portions 121 is provided with a resilient body 124, as illustrated in FIGS. 2-5. It can be seen from the structure of one rotating portion 113 and one mounting portion 121, the positioning slots 115 are juxtaposed with the releasing plate 114, and arranged about the center of the releasing plate 114 as a center of circle. The resilient body 124 is provided inside the connecting slot 122 and possibly located into one of the positioning slots 115 so as to position the temple 12 in the present location. In this case, the resilient body 124 is provided with a spring 125 and a metal ball 126, as well as the metal ball 126 is located at one end of the spring 125, such that the spring 125 is capable of butting the metal ball 126 into one of the positioning slots 115. In another embodiment, each of the rotating portions 113 is provided with a plurality of resilient ratchets (not shown in the figures), and each of the mounting portions 121 is provided with a plurality of fixed ratchets (not shown in the figures). It can be seen from the structure of one rotating portion 113 and one mounting portion 121, the resilient ratchets are juxtaposed with the releasing plate 114, and arranged about the center of the releasing plate 114 as a center of circle. The fixed ratchets are provided inside the connecting slot 122 and then engaged with the resilient ratchets so as to position the temple 12 in the present location.

Next, the eyeglass with angle of lens adjustable depending on multi focus lens is provided with a plurality of fixed positions. In one embodiment, each of the two temples 12 may be respectively defined to form the fixed positions by locating one of the resilient bodies 124 into any one of the positioning slots 115. In another embodiment, each of the two temples 12 is respectively defined to form the fixed positions by engaging the fixed ratchets with any number of the resilient ratchets. In this case, the number of the fixed positions is larger than or equal to that of the vision zones.

What is claimed is:

1. A eyeglass with angle of lens adjustable depending on multi focus lens, comprising:
a frame having a rim and two temples provided at two opposite outer sides of the frame, the rim having a bottom side defined and formed by the bottom of the rim, a top side defined and formed by the top of the rim, and two rotating portions located at two opposite outer sides of the rim, each of the two temples having a mounting portion pivotally connected to one of the rotating portions, each of the rotating portions having a releasing plate, each of the mounting portions having a connecting slot provided for one of the rotating portions to be situated therein, and an axle hole provided on an inner wall of the connecting slot and provided for one of the releasing plates to be situated therein, such that the temple is allowed to revolve around one of the releasing plates as an axle center, each of the rotating portions having a plurality of resilient ratchets juxtaposed with the releasing plate, and arranged about the center of the releasing plate as a center of circle, each of the mounting portions having a plurality of fixed ratchets provided inside the connecting slot and engaged with the resilient ratchets; and
two lenses mounted to the rim symmetrically, each of the lenses having two irregular-prescription areas, and a regular-prescription area located between the two irregular-prescription areas, each of the regular-prescription areas having a plurality of vision zones;
wherein the vision zones comprise a short-range vision zone, a middle-range vision zone and a long-range vision zone provided from the bottom side of the rim toward the top side of the rim in turn, the prescription of the short-range vision zone being the presbyopic prescription of a user, the prescription of the long-range vision zone being the prescription of the short-range vision zone divided by two, the prescription of the middle-range vision zone being equivalent to the summation of prescription of the short-range vision zone and that of the long-range vision zone divided by two.

2. The eyeglass with angle of lens adjustable depending on multi focus lens according to claim 1, wherein the vision zones further comprise a shortest-range vision zone located between the bottom side and the short-range vision zone, the prescription of the shortest-range vision zone being the prescription of the short-range vision zone plus 0.15 to 0.6 diopters.

3. The eyeglass with angle of lens adjustable depending on multi focus lens according to claim 2, wherein the vision zones further comprise a longest-range vision zone located between the top side and the long-range vision zone, the prescription of the longest-range vision zone being the prescription of the long-range vision zone plus 0.15 to 0.6 diopters.

4. The eyeglass with angle of lens adjustable depending on multi focus lens according to claim 1, wherein the eyeglass with angle of lens adjustable depending on multi focus lens is provided with a plurality of fixed positions, where the fixed ratchets are engaged with any number of the resilient ratchets for the two temples, the number of the fixed positions being larger than or equal to that of the vision zones.
